(19) United States
(12) Patent Application Publication
(10) Pub. No.: US 2006/0002114 A1
(43) Pub. Date: Jan. 5, 2006

(54) LED lamp with curving cylinder lens

(75) Inventor: Wen-Hsin Sun, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/977,821

(22) Filed: Oct. 29, 2004

(30) Foreign Application Priority Data
Jul. 2, 2004 (TW) 93210524

(51) Int. Cl. F21S 6/00

(52) U.S. Cl. 362/257

(57) ABSTRACT

An LED (light emitting diode) lamp includes a baseboard (10), an LED (30), a holder (20), a first lens (40), and a cylinder lens (42). The LED is set on the baseboard, the holder is set on the baseboard surrounding the LED, the first converging lens is mounted in the holder and located above the LED, and the cylinder lens is mounted in the holder above the first lens. In an alternative embodiment, the first lens and the cylinder lens are replaced by a single curving cylinder lens (44). The LED lamp can converge the intensity of illumination and can flatten the range of illumination.

### BACKGROUND OF THE INVENTION

1. Field of the Invention

The present invention relates to light emitting diodes used in devices such as digital still camera modules of portable electronic devices.

2. Description of Related Art

LEDs (light emitting diodes) were first discovered and publicized in the 1960s. Since that time, and with the benefit of vast improvements in semiconductor wafer technology and encapsulation technology, the lamp efficiency of LEDs has improved exponentially. For red and orange lamps, the lamp efficiency has improved from 1 lm/W (lumen/watt) originally to 100 lm/W. For green lamps, the lamp efficiency has improved from 1 lm/W to 50 lm/W. The lamp efficiency of all LEDs far exceeds that of traditional incandescent bulbs. Moreover, LEDs are smaller, lighter in weight, consume less energy, and have longer lifetimes. LEDs are widely accepted as the light source of choice for household lamps, camera flashlights, traffic lights, automobile headlights, etc.

The flashlight source of a camera is usually an LED. A typical flashlight assembly has a lamp set on a baseboard providing power thereto, and a reflective cover set on the baseboard above the lamp to converge the light beams emitted from the lamp. The flashlight assembly has a radiation angle, which should be equal to or greater than the angle of vision of a lens of the camera. Otherwise, edge portions of the photo taken may be dull or darkened. The radiation angle of an LED is relatively large, which makes it hard to converge the intensity of illumination of the LED. If the range of illumination is too large, it may be necessary to increase the power of the LED in order to provide sufficient intensity of illumination within the angle of vision of the lens. However, a high-power LED consumes much electricity.

The headlights of an automobile must provide high intensity illumination over a long distance. The range of illumination of a headlight is conventionally configured to be round. However, in practice, upper and lower areas of the range of illumination tend to be unduly bright, and opposite side areas of the range of illumination tend to be relatively dark. Thus when two automobiles approach each other at night, the headlights of each vehicle are liable to cause the driver of the other vehicle to experience glare. Moreover, the relatively poor side illumination may be insufficient for a driver to avoid hazards. Both these problems increase the risk of traffic accidents occurring.

A new LED lamp which overcomes the various above-described problems is desired.

### SUMMARY OF THE INVENTION

Accordingly, an object of the present invention is to provide an LED lamp which can converge an intensity of illumination and flatten a range of illumination.

To achieve the above object, an LED lamp of a first preferred embodiment of the present invention comprises a baseboard, an LED, a holder, a first converging lens and a cylinder lens. The LED is set on the baseboard, the holder is set on the baseboard surrounding the LED, the first lens is mounted in the holder and located above the LED, and the cylinder lens mounted in the holder above the first lens.

Further, an LED lamp of a second preferred embodiment of the present invention comprises a baseboard, an LED, a holder and a curving cylinder lens. The LED is set on the baseboard, the holder is set on the baseboard surrounding the LED, and the curving cylinder lens is mounted in the holder above the LED.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic, cross-sectional view of an LED lamp of the first preferred embodiment of the present invention; and

FIG. 2 is a schematic, cross-sectional view of an LED lamp of the second preferred embodiment of the present invention.

### DETAILED DESCRIPTION OF THE INVENTION

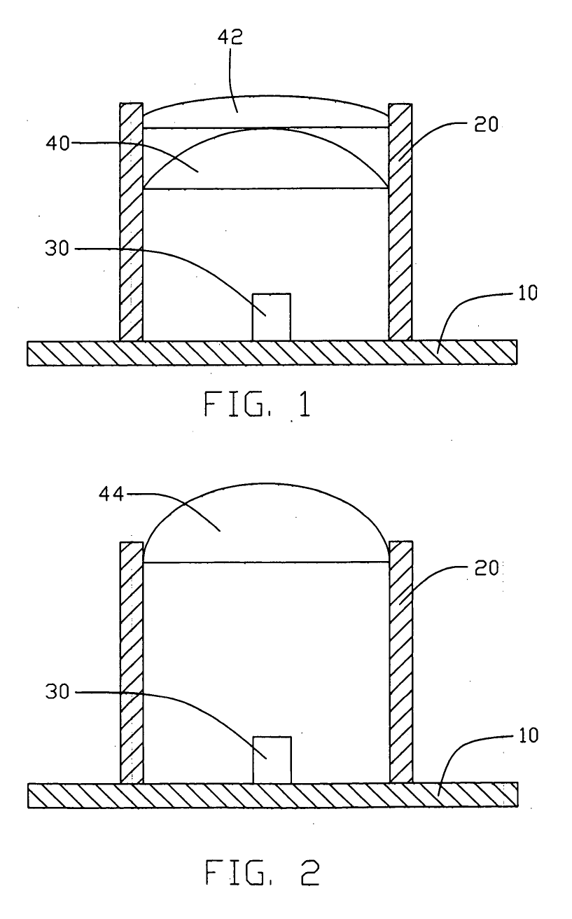

Referring to FIG. 1, an LED lamp as an illuminating apparatus in accordance with the first preferred embodiment of the present invention includes a baseboard 10, a holder 20, an LED 30 as a light source, a first lens 40, and a cylinder lens 42.

The baseboard 10 is made of an epoxy resin, and the LED 30 is set on the baseboard 10 and electrically connected therewith. The holder 20 is cylindrical, and defines top and bottom openings. The holder 20 is set on the baseboard 10 surrounding the LED 30. The first lens 40 is a sub-hemispherical converging lens, and is mounted in an upper portion of the holder 20. The cylinder lens 42 is mounted in the top opening of the holder 20 above the first lens 40. The first lens 40 and the cylinder lens 42 are located above the LED 30, so that light beams emitted from the LED 30 pass through the first lens 40 and the cylinder lens 42.

The spread of angles of the light beams emitted from the LED 30 is reduced by the first lens 40. The curved surface of the cylinder lens 42 converges light in the direction which is perpendicular to an axis of the cylinder lens 42. Therefore converged light transmitting from the first lens 40 is further converged relatively closer to the axis of the cylinder lens 42. Thus, the illumination provided by the LED lamp is concentrated and “flattened.” In FIG. 1, the resulting range of illumination on an object surface would be elliptical, with the long axis of the ellipse also being perpendicular to the page.

Referring to FIG. 2, an LED lamp in accordance with the second preferred embodiment of the present invention includes the baseboard 10, the holder 20, the LED 30 and a curving cylinder lens 44. The curving cylinder lens 44 is mounted in the top opening of the holder 20, and is located above the LED 30.

In FIG. 2, the curving cylinder lens 44 defines an axis. The optical characteristics of the curving cylinder lens 44 are such that it converges all light received from the LED 30. However, light whose spread direction is perpendicular to the axis is converged more than other light. Thus the illumination provided by the LED lamp is concentrated and “flattened.” In FIG. 2, the resulting range of illumination on an object surface would be elliptical, with the long axis of the ellipse also being perpendicular to the page. In other words, the curving cylinder lens 44 of the second embodiment has similar optical characteristics to the combined first lens 40 and cylinder lens 42 of the first embodiment, and provides a similar result to that provided by the combined first lens 40 and cylinder lens 42.

In summary, the unique advantage of the LED lamp of the present invention is that the illumination thereof is more convergent, particularly with respect to one axis of a range of illumination. Thus, for example, when two LED lamps are used as the headlights of an automobile, glare can be reduced and hazards can be more clearly illuminated. This enhances road safety.

Although the present invention has been described with specific terms, it should be noted that the described embodiments are not necessarily exclusive, and that various changes and modifications may be made thereto without departing from the scope of the present invention as defined in the appended claims.

I claim:

1. An LED (light emitting diode) lamp, comprising:
a baseboard;
an LED set on the baseboard;
a holder set on the baseboard and surrounding the LED;
a first lens mounted in the holder and located above the LED; and
a cylinder lens set in the holder.

2. The LED lamp as described in claim 1, wherein the baseboard is made of an epoxy resin.

3. The LED lamp as described in claim 1, wherein the holder is cylindrical, and defines a top opening.

4. The LED lamp as described in claim 1, wherein the cylinder lens is mounted above the first lens.

5. An LED (light emitting diode) lamp, comprising:
a baseboard;
an LED set on the baseboard;
a holder set on the baseboard and surrounding the LED; and
a curving cylinder lens mounted in the holder above the LED.

6. The LED lamp as described in claim 5, wherein the baseboard is made of an epoxy resin.

7. The LED lamp as described in claim 5, wherein the holder is cylindrical, and defines a top opening.

8. An illuminating apparatus comprising:
a point light source;
a lens set adapted to receive light from said point light source and stretching said light into a line-like light after passing of said light through said lens set.

9. The illuminating apparatus as described in claim 8, wherein said lens set includes a cylindrical lens.

10. The illuminating apparatus as described in claim 9, wherein said lens set includes a first lens used to converge said light, and said cylindrical lens is convergent.

11. The illuminating apparatus as described in claim 8, wherein said lens set includes a curving cylindrical lens having light-convergent function.
